(19) United States
(12) Patent Application Publication
(10) Pub. No.: US 2021/0244047 A1
(43) Pub. Date: Aug. 12, 2021

(54) PROCESS FOR IMPROVING RUMINAL DEGRADATION OF WHEAT STRAW

(71) Applicant: LESAFFRE ET COMPAGNIE, Paris (FR)

(72) Inventors: Christine JULIEN, Sepx (FR); Jean-Philippe MARDEN, Labege (FR)

(73) Assignee: LESAFFRE ET COMPAGNIE, Paris (FR)

(21) Appl. No.: 16/972,772

(22) PCT Filed: Jun. 4, 2019
(86) PCT No.: PCT/FR2019/051327

§ 371 Date: Dec. 7, 2020

(30) Foreign Application Priority Data
Jun. 5, 2018 (FR) 18 54870

(51) Int. Cl. A23K 10/16; A23K 10/30; A23K 50/10

(52) U.S. Cl. CPC A23K 10/16; A23K 50/10; A23K 10/30

(57) ABSTRACT

A process for improving wheat straw degradation in a ruminant, including a step of feeding the ruminant with the wheat straw, wherein the process is characterized in that it also includes a step of administering a prebiotic chosen from an autolysed yeast, a yeast extract, a yeast wall fraction or mixtures thereof, the administrating of the prebiotic being carried out before, after or simultaneously with the step of feeding the ruminant. Also, the use, in a ruminant, of a prebiotic chosen from an autolysed yeast, a yeast extract, a yeast wall fraction or mixtures thereof, before, after or during the feeding of the ruminant with wheat straw.

### FIELD OF THE INVENTION

The present invention relates to the agricultural field of animal nutrition and concerns a process for improving ruminal degradation of fodder.

### TECHNOLOGICAL BACKGROUND

Wheat straw represents an inexpensive resource which could contribute to reinforcement of fodder and feed autonomy of certain ruminant farms. Moreover, in certain geographical zones, fodder represents a qualitatively very important resource which could be upgraded advantageously in animal nutrition.

However, the use of wheat straw is limited in the case of ruminants with a high level of production, such as bovines in particular. Effectively, despite its richness in fiber, wheat straw has a low nutritional value owing to poor digestion by ruminants. In fact, from a chemical viewpoint, the presence of bonds between the constituents of the plant wall leads to a variable level of resistance to attack by the ruminal digestive microbiota. This resistance is reflected in poor ruminal degradation of fodder in the animal.

Thus, in order to improve degradation of fodder, and notably of wheat straw, research has been undertaken for decades. Thus, it has been demonstrated that having recourse to chemical and/or enzymatic pretreatments made it possible to improve ruminal degradation.

It has also been demonstrated that the use of live yeasts made it possible to improve the degradation of wheat straw. Thus, for example, it is shown in the work of Muazzez Cömert et al. (Asian-Australasian Journal of Animal Sciences, Vol. 28, No. 5, 2015) that when sheep were administered wheat straw pretreated chemically with ammonia and Saccharomyces cerevisiae live yeast this improved the degradation of the wheat straw.

There is, however, still to this day a need for new methods for improving ruminal degradation of wheat straw, said methods being inexpensive and allowing application on the scale of a farm. Upgrading of wheat straw thus makes it possible to improve the fodder autonomy and overall autonomy of the farm.

The inventors have been able to elaborate a method for responding to some or all of the problems of the prior art. The inventors in fact discovered, surprisingly, that the administration of non-live yeasts to ruminants gave an effective improvement in degradation of wheat straw.

Advantageously, according to the invention it is not necessary to carry out chemical preprocessing of the wheat straw: just the use of non-live yeasts is sufficient.

Non-live yeasts notably have the advantage, relative to live yeasts, of far lower costs, they are easier to handle, do not present constraints with respect to storage, stability or packaging, and do not have regulatory constraints etc.

### SUMMARY OF THE INVENTION

The invention relates firstly to a process for improving the degradation of wheat straw in a ruminant comprising a step of feeding the ruminant with wheat straw, said method being characterized in that it further comprises a step of administering a prebiotic selected from an autolyzed yeast, a yeast extract, a yeast cell wall fraction or mixtures thereof, said administration of the prebiotic being carried out before, after or simultaneously with the step of feeding said ruminant.

The invention relates secondly to the use, in a ruminant, of a prebiotic selected from an autolyzed yeast, a yeast extract, a yeast cell wall fraction or mixtures thereof, before, after or during feeding of said ruminant with wheat straw.

### DETAILED DESCRIPTION

The invention relates firstly to a process for improving the degradation of wheat straw in a ruminant, comprising a step of feeding said ruminant with wheat straw, said process being characterized in that it further comprises a step of administering a prebiotic selected from an autolyzed yeast, a yeast extract, a yeast cell wall fraction or mixtures thereof, and preferably a yeast extract.

Degradation is defined as the ruminal degradation of feedstuffs under the action of the microorganisms of the ruminoreticulum in ruminants.

In the sense of the present invention, the term “prebiotic” denotes a nondigestible nutrient which, through its metabolization by the microorganisms of the ruminoreticulum, modulates the composition and/or activity of the ruminal microbiota, thereby conferring a physiological benefit for the host.

The process according to the invention therefore makes it possible to improve the degradation of wheat straw when the latter is used for feeding a ruminant.

In fact, the process that has been elaborated makes it possible to stimulate the fermentation activity of the microbiota and in particular the fibrolytic activity thus making it possible to improve the degradation of wheat straw.

The extent of this degradation determines the digestibility in the whole alimentary canal, and consequently the energy value of the ruminant's diet.

Digestibility is a criterion that defines the degree to which organic matter is digested by an animal.

Moreover, by improving the degradation of wheat straw, the process according to the invention also allows better upgrading thereof as animal feed, because at present it is underutilized owing to the difficulties that ruminants have in digesting it compared to other feedstuffs and in particular other fodder.

The First Step of the Process According to the Invention Therefore Consists of Feeding an Animal with Wheat Straw.

Wheat straw corresponds to the agricultural product represented by the part of the stem or stubble of wheat. The wheat straw supplied is that conventionally used by a person skilled in the art for animal feed and may be in various forms, both in the form of straw bales and in bulk form.

According to a particular embodiment, the straw may first undergo a step of mechanical processing, the purpose of which is to reduce the size of the strands and allow both better accessibility of the fibers to subsequent treatments if needed and better degradation. According to this particular embodiment, the wheat straw may first undergo chopping, tearing or defibration, or else grinding.

This feeding step is a conventional step familiar to a person skilled in the art of farming. The animals are then fed with the wheat straw. Preferably, the animals are ruminants, for example such as cows or steers.

According to the invention it is not necessary to pretreat the wheat straw chemically (for example with ammonia) before administering it to the ruminant.

### The Second Step of the Process According to the Invention Consists of Administering a Prebiotic to the Animal.

The step of administration consists of administering the prebiotic to the ruminant so that it ends up in the ruminoreticulum of said ruminant.

An example of administration of the prebiotic is the oral route.

This step of administration may be carried out before, simultaneously or after the step of feeding the ruminant with wheat straw. Preferably the step of administration is carried out simultaneously with the feeding step.

“Before” the feeding step signifies at most 24 hours before. Thus, the prebiotic will never be administered more than 24 hours before administration of the wheat straw. Preferably the prebiotic will be administered 2 to 8 hours before administration of the wheat straw.

Similarly, “after” the feeding step signifies at most 24 hours afterwards. Thus, the prebiotic will never be administered more than 24 hours after administration of the wheat straw. Preferably the prebiotic will be administered 2 to 8 hours after administration of the wheat straw.

Quite surprisingly, the inventors in fact found that a step of administering a prebiotic made it possible to improve the degradation of wheat straw significantly.

Preferably, the prebiotic is a yeast extract or an autolyzed yeast.

Conventionally, yeast extract, the yeast cell wall fraction and autolyzed yeast are obtained by a process of autolysis. Yeast extract and the yeast cell wall fraction comprise an additional step of separating the soluble fraction and the insoluble fraction; yeast extract corresponds to the soluble fraction and the insoluble fraction corresponds to the yeast cell wall fraction.

Processes for obtaining yeast extracts are known in the prior art (see for example the reference work “Yeast Technology”, 2nd edition, 1991, G. Reed and T. W. Nogodawithana, published by Van Nostrand Reinhold, N.Y., ISBN 0-442-31892-8).

According to a particular embodiment, the prebiotic according to the invention is obtained from a yeast of the genus Saccharomyces and more particularly of the species Saccharomyces cerevisiae.

According to another embodiment of the invention, the ruminant belongs to the Bovidae family. The bovide family (Bovidae) comprises several subfamilies, notably including the Bovinae (which includes the bovines) and the caprines (which includes sheep and goats).

A large ruminant is selected from adult bovines or those in the growth phase.

A small ruminant is selected from sheep and goats, adult or in the growth phase.

According to a particular embodiment, the prebiotic is administered at a dose from 2 to 20 g/head/day for large ruminants, namely bovines, preferably a dose from 5 to 10 g/head/day.

The prebiotic is administered at a dose from 0.5 to 5 g/head/day for small ruminants, namely sheep and goats, preferably a dose from 1 to 2 g/head/day.

The prebiotic is in a form suitable for administration to animals. Thus, the prebiotic may be in the form of capsules, bolus, powder, or granules. Preferably, the prebiotic is in the form of powder.

A capsule is a solid preparation, consisting of a hard or soft envelope of variable shape and capacity.

A tablet or bolus is a solid preparation containing a unit dose of one or more active ingredients (or preparation). They are obtained by compressing a constant volume of particles. When intended for livestock, they are larger and are then called a bolus.

According to a particular embodiment of the invention, when the prebiotic is administered simultaneously with the wheat straw, said prebiotic may for example be in the form of powder, which will then be mixed with the wheat straw. The mixture is then used for feeding the ruminant.

The improvement in degradation of wheat straw can be determined by the techniques known by a person skilled in the art, for example such as by measuring the loss of dry matter through incubation in ruminal fluid. The details of the measurements are presented in the example section given hereunder.

The process according to the invention is particularly advantageous as it makes it possible, surprisingly, to improve the degradation of wheat straw in the rumen and thus better assimilation of the wheat straw by the animal.

The process of the invention is simple to implement, and inexpensive, in the sense that it only requires the use of non-live yeasts.

Therefore an advantage of the present invention is that it has been possible to develop a process allowing improvement of the degradation of straw, and said process can be employed at the scale of a farm without requiring extra work or a detrimental extra cost. On the contrary, the process according to the invention makes it possible to potentiate wheat straw and thus allows the animals to have better digestion with respect to this feed, which sometimes constitutes one of the main resources.

Thanks to the process according to the invention, wheat straw is better utilized by the ruminants and it is simpler for farms to aim for feed self-sufficiency without generating a large extra cost.

The invention relates secondly to the use, in a ruminant, of a prebiotic selected from an autolyzed yeast, a yeast extract, a yeast cell wall fraction or mixtures thereof, before, after or simultaneously with feeding the ruminant with wheat straw.

Preferably, the prebiotic is a yeast extract or an autolyzed yeast.

According to a particular embodiment, in the use as defined above, the prebiotic is administered at a dose from 2 to 20 g/head/day for large ruminants, namely bovines, and preferably at a dose from 5 to 10 g/head/day.

The prebiotic is administered at a dose from 0.5 to 5 g/head/day for small ruminants, namely sheep and goats, preferably at a dose from 1 to 2 g/head/day.

The prebiotic is in a form suitable for administration to animals. Thus, the prebiotic may be in the form of capsules, a bolus, powder, or granules. Preferably, the prebiotic is in the form of powder.

The use according to the invention is particularly advantageous as it can improve the degradation of wheat straw by animals. In fact, the process that has been developed makes it possible to stimulate the fermentation activity of the microbiota and in particular the fibrolytic activity, thus making it possible to improve the degradation of wheat straw.

The invention will be better understood from the examples given hereunder, which are intended purely for purposes of illustration and in no case represent a limitation.

### FIGURE

FIG. 1: Effect of the prebiotic on the degradation of the dry matter of wheat straw (in percentage % disappearance/degradation of the dry matter of wheat straw).

### EXAMPLES

### Materials and Methods

1. Preparation of the Fermentation Modules

The wheat straw is ground to a mesh of 2 cm (Electra) and then the fines are removed using a 1.18 mm sieve (Penn State Separator).

Fractions of 3 g are then weighed in triplicate and placed in bottles equipped with a pressure measuring module (Ankom Technology).

2. Prebiotic

In order to recreate the in vivo conditions of the co-administration of wheat straw and of the prebiotic according to the process of the invention, the prebiotic is added to the modules at the moment of incubation with the ruminal fluid.

The prebiotic used is yeast extract or autolyzed yeast, respectively, each obtained from the strain deposited with the National Collection of Cultures of Microorganisms (CNCM) on Jan. 31, 2018 under number CNCM 1-5268.

The prebiotic is administered at a dose of 0.4 g/module (i.e. per 3 g of straw).

3. Obtaining the Ruminal Fluid for Fermentation

The ruminal contents are collected about 2 hours after a meal from dry dairy cows, fitted with a ruminal cannula and fed with a ration based on wheat straw, maize silage and a mineral and vitamin supplement.

After collection, the ruminal contents are filtered through a metal sieve of mesh 1.6 mm in order to obtain the ruminal fluid.

The ruminal fluid is then mixed with a buffer solution of pH=7 (ratio 1:1) to form the incubation medium. The latter is bubbled with oxygen-free CO₂.

4. Preparation of the Fermentation Modules

Several modules are prepared. The composition of the different modules and their distribution within the test are presented below:

Test: Wheat straw and prebiotic (cf. point 2 above).
3 modules containing wheat straw and yeast extract, hereinafter EXL;
3 modules containing wheat straw and autolyzed yeast, hereinafter LA;
3 control modules (C).

The blank modules, 3 in number, contain only the incubation medium as described in point 3 of the present example.

The incubation bottles receive 200 ml of incubation medium each, and then are saturated with oxygen-free CO₂. The amount of straw in each module is 3 grams.

5. Measurement of the Degraded Dry Matter

The bottles are incubated at 39° C. for 96 h to allow fermentation.

After 96 h of incubation, the modules are put in ice in order to stop fermentation. The amount of undegraded dry matter is then measured by filtering and drying the incubation residue at 60° C. for 4 days (called residue hereinafter).

The incubated substrate corresponds to wheat straw.

The disappearance of dry matter (in percentage %) is calculated from the following formula:

[incubated substrate−(residue of the incubated substrate−residue of the control module)]/incubated substrate×100

Whether for the incubated substrate, the residues of the incubated substrate or of the control module, it is the mean value of the results obtained for the modules of one and the same treatment.

6. Statistical Analysis

The results for degradation of dry matter (in percentages %) were submitted to an analysis of variance using the linear general univariate model of the software for statistical analysis of data SPSS® (IBM®, SPSS®, version 22). The model integrates the effects of the covariable and of the products, the covariable being the degradation of the dry matter of the controls (in percentage %). A log 10 transformation of the values expressed as a percentage was carried out for the analysis.

The results are regarded as not significant when P>0.05.

The different letters a, b, c used indicate whether the values are significantly different or not. Thus, the results are not significantly different when the same letter is reported (P>0.05).

### Results

### Effect of the Prebiotic on the Degradation of Wheat Straw

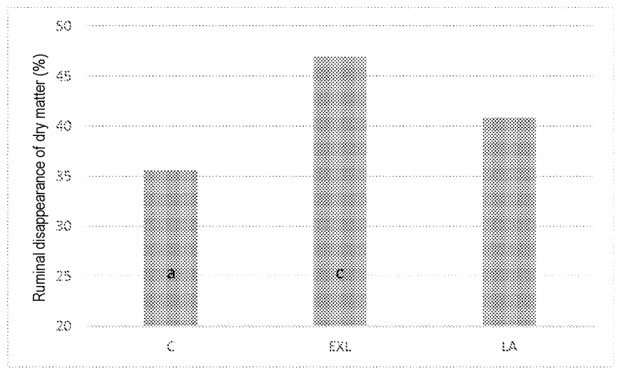

The results in FIG. 1 show that the degradation of the dry matter is increased significantly in the presence of the prebiotic, whether it is the yeast extract or the autolyzed yeast, the yeast extract giving higher performance than the autolyzed yeast. The use of a prebiotic therefore improves the degradation of wheat straw in vitro.

The process according to the invention is therefore particularly advantageous in that it makes it possible to improve the degradation of wheat straw.

1-9. (canceled)

10. A process for improving the degradation of wheat straw in a ruminant comprising a step of feeding the ruminant with wheat straw, said process being characterized in that it further comprises a step of administering a prebiotic selected from an autolyzed yeast, a yeast extract, a yeast cell wall fraction or mixtures thereof, and preferably a yeast extract.

11. The process as claimed in claim 10, wherein the step of administering the prebiotic is carried out before, after or simultaneously with feeding the ruminant with wheat straw, preferably simultaneously.

12. The process as claimed in claim 10, wherein the ruminant belongs to the Bovidae family.

13. The process as claimed in claim 10, wherein the prebiotic is administered at a dose between 2 and 20 g/head/day for large ruminants, namely bovines, and preferably a dose between 5 and 10 g/head/day.

14. The process as claimed in claim 10, wherein the prebiotic is administered at a dose between 0.5 and 5 g/head/day for small ruminants, namely sheep and goats, and preferably at a dose between 1 and 2 g/head/day.

15. The process as claimed in claim 10, wherein the prebiotic is in the form of powder.

16. A process for improving degradation of wheat straw in a ruminant, comprising administering a prebiotic selected from an autolyzed yeast, a yeast extract, a yeast cell wall fraction or mixtures thereof, before, after or simultaneously with feeding the ruminant with wheat straw, preferably simultaneously with feeding the ruminant.

17. The process as claimed in claim 16, wherein the prebiotic is administered at a dose between 2 and 20 g/head/day for large ruminants, namely bovines, and preferably at a dose between 5 and 10 g/head/day.

18. The process as claimed in claim 16, wherein the prebiotic is administered at a dose between 0.5 and 5 g/head/day for small ruminants, namely sheep and goats, and preferably at a dose between 1 and 2 g/head/day.
